(19) United States
(12) Patent Application Publication
(10) Pub. No.: US 2006/0125738 A1
(43) Pub. Date: Jun. 15, 2006

(54) Light emitting display and method of driving the same

(76) Inventors: Yang Wan Kim, Seoul (KR); Naoaki Komiya, Suwon (KR)

Correspondence Address: H.C. PARK & ASSOCIATES, PLC, 8500 LEESBURG PIKE, SUITE 7500, VIENNA, VA, 22182, US

(21) Appl. No.: 11/274,212

(22) Filed: Nov. 16, 2005

(30) Foreign Application Priority Data
Nov. 17, 2004 (KR) 10-2004-0094190

(51) Int. Cl. G09G 3/30

(52) U.S. Cl. 345/76

(57) ABSTRACT

A light emitting display including a scan driver for supplying scan signals to scan lines in a first period of a horizontal period, a data driver for sequentially supplying a plurality of data signals to an output line in a second period of the horizontal period, a demultiplexer coupled with the output line and supplying the data signals to a plurality of data lines, respectively, and an image display including a plurality of pixels. The data lines include a capacitor for storing voltages corresponding to the data signals. A last data signal supplied in the second period is supplied to overlaps a scan signal.

### CROSS-REFERENCE TO RELATED APPLICATIONS

This application claims priority to and the benefit of Korean Patent Application No. 10-2004-0094190, filed on Nov. 17, 2004, which is hereby incorporated by reference for all purposes as if fully set forth herein.

### BACKGROUND OF THE INVENTION

1. Field of the Invention

The present invention relates to a light emitting display and a method of driving the same, and more particularly to a light emitting display having fewer data driver output lines and a method of driving the same.

2. Discussion of the Background

Recently, various flat panel displays have been developed to replace the heavier and bulkier cathode ray tubes (CRT). Such flat panel displays include liquid crystal displays (LCD), field emission displays (FED), plasma display panels (PDP), and light emitting displays.

Light emitting displays are self-emissive devices that emit light by re-combination of electrons and holes. The light emitting displays may have high response speed, and they may have relatively low power consumption. A typical light emitting display supplies current corresponding to a data signal to an organic light emitting diode (OLED) using a thin film transistor (TFT) formed in each pixel so that the OLED emits light.

FIG. 1 shows a conventional light emitting display.

Referring to FIG. 1, the conventional light emitting display includes an image display 30 that has pixels 40 formed at the intersections between scan lines S1 to Sn and data lines D1 to Dm, a scan driver 10 for driving the scan lines S1 to Sn, a data driver 20 for driving the data lines D1 to Dm, and a timing controller 50 for controlling the scan driver 10 and the data driver 20.

The scan driver 10 generates scan signals in response to scan driving control signals SCS from the timing controller 50, and it sequentially supplies the generated scan signals to the scan lines S1 to Sn. The scan driver 10 also generates emission control signals in response to the scan driving control signals SCS, and it sequentially supplies the generated emission control signals to the emission control lines E1 to En.

The data driver 20 generates data signals in response to data driving control signals DCS from the timing controller 50, and it supplies the generated data signals to the data lines D1 to Dm. The data driver 20 supplies a data signal of one horizontal line to the data lines D1 to Dm every horizontal period.

The timing controller 50 generates the data driving control signals DCS and the scan driving control signals SCS corresponding to externally supplied synchronizing signals and supplies the data driving control signals DCS to the data driver 20 and the scan driving control signals SCS to the scan driver 10. The timing controller 50 re-aligns externally received image data and supplies a data signal Data to the data driver 20.

The image display 30 receives a first power ELVDD and a second power ELVSS. Here, the first power ELVDD and the second power ELVSS are supplied to the pixels 40, respectively. The pixels 40 that receive the first power ELVDD and the second power ELVSS generate light components corresponding to the data signals supplied thereto, respectively. The emission times of the pixels 40 are controlled in accordance with the emission control signals.

In the conventional light emitting display driven as described above, the pixels 40 are arranged at the intersections between the scan lines S1 to Sn and the data lines D1 to Dm. Here, the data driver 20 includes m output lines for supplying data signals to the m data lines D1 to Dm, respectively. That is, in the conventional light emitting display, the data driver 20 has the same number of output lines as data lines D1 to Dm. Therefore, a plurality of data driving circuits are included in the data driver 20 so that m output lines are included. Consequently, manufacturing cost increases. In particular, as the display's resolution and screen size increase, the data driver 20 includes more output lines, which increases manufacturing costs.

### SUMMARY OF THE INVENTION

The present invention provides a light emitting display having fewer data driver output lines and a method of driving the same.

Additional features of the invention will be set forth in the description which follows, and in part will be apparent from the description, or may be learned by practice of the invention.

The present invention discloses a light emitting display including a scan driver for supplying scan signals to scan lines in a first period of a horizontal period, a data driver for sequentially supplying a plurality of data signals to an output line in a second period of the horizontal period, a demultiplexer coupled with the output line and supplying the data signals to a plurality of data lines, respectively, and an image display including a plurality of pixels coupled with the scan lines and the data lines. The data lines comprise a capacitor for storing voltages corresponding to the data signals. A last data signal supplied in the second period of a first horizontal period overlaps a scan signal supplied in the first period of a second horizontal period.

The present invention also discloses a method of driving a light emitting display including supplying a scan signal in a first period of a horizontal period, and supplying a plurality of data signals to an output line of a data driver in a second period of the horizontal period. A last data signal supplied in the second period overlaps a scan signal.

The present invention also discloses a method of driving a light emitting display including sequentially supplying scan signals, and sequentially supplying i control signals in order to turn on i transistors coupled between an output line of a data driver and i (i is a natural number) data lines. At least one control signal among the i control signals is supplied to overlap a scan signal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows a conventional light emitting display.

FIG. 2 shows a light emitting display according to an exemplary embodiment of the present invention.

FIG. 3 is a circuit diagram showing a demultiplexer of FIG. 2.

FIG. 4A and FIG. 4B are waveforms showing a method of driving a light emitting display according to an exemplary embodiment of the present invention.

FIG. 5 is a circuit diagram showing an exemplary embodiment of the pixel of FIG. 2.

FIG. 6 shows a demultiplexer coupled with pixels according to an exemplary embodiment of the present invention.

FIG. 7A and FIG. 7B are waveforms showing a method of driving a light emitting display according to another exemplary embodiment of the present invention.

### DETAILED DESCRIPTION OF ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity.

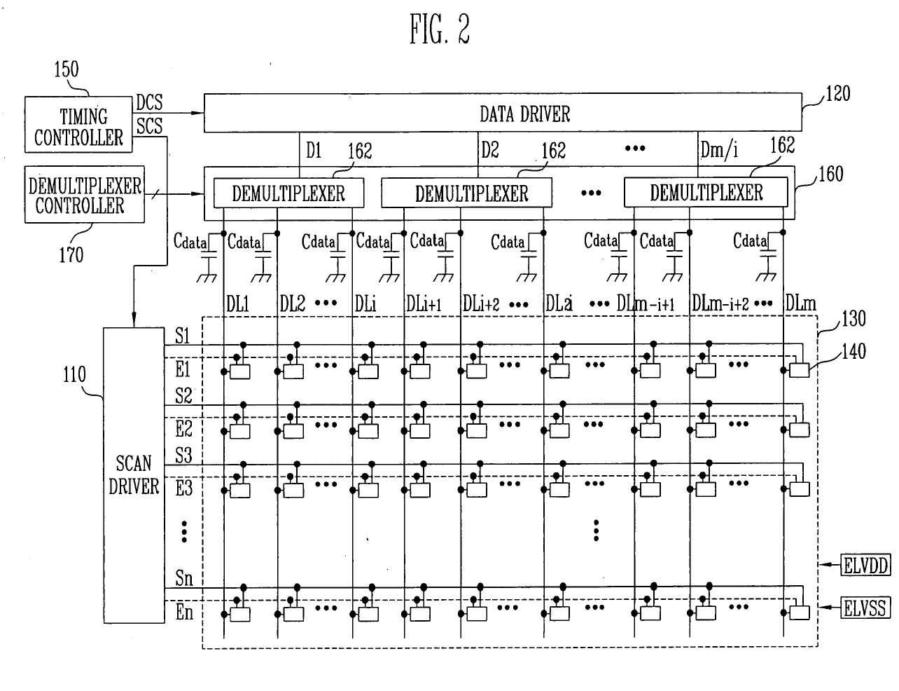

FIG. 2 shows a light emitting display according to an exemplary embodiment of the present invention.

Referring to FIG. 2, the light emitting display includes a scan driver 110, a data driver 120, an image display 130, a timing controller 150, a demultiplexer block 160, a demultiplexer controller 170, and data capacitors Cdata.

The image display 130 includes a plurality of pixels 140 arranged at crossing regions of the scan lines S1 to Sn and the data lines DL1 to DLm. The pixels 140 generate light components corresponding to the data signals supplied thereto from the data lines DL1 to DLm, respectively.

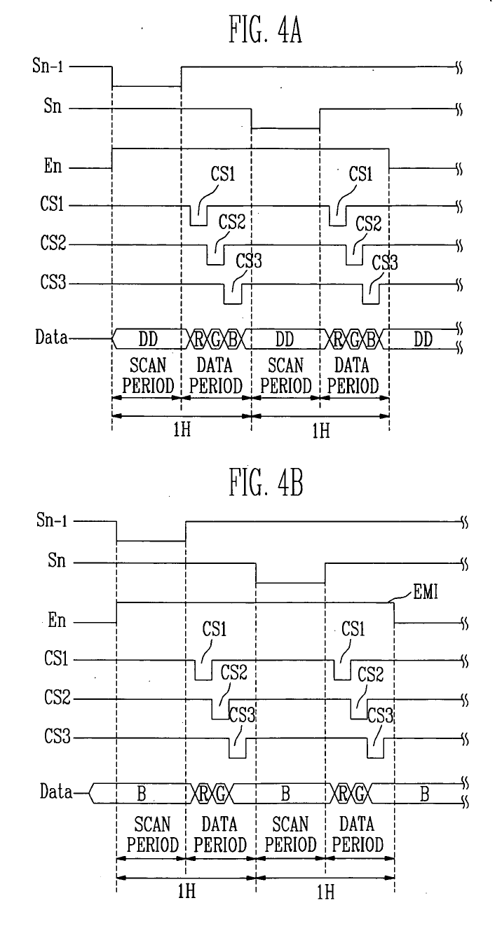

The scan driver 110 generates scan signals in response to scan driving control signals SCS supplied from the timing controller 150 and sequentially supplies the generated scan signals to the scan lines S1 to Sn. Here, as shown in FIG. 4A, the scan driver 110 supplies the scan signals in a partial period of a horizontal period 1H.

More specifically, a horizontal period 1H is divided into a scan period (a first period) and a data period (a second period). The scan driver 110 supplies the scan signals to the scan lines S1 to Sn during the scan period of the horizontal period 1H and not during the data period. The scan driver 10 also generates emission control signals in response to the scan driving control signals SCS and sequentially supplies the generated emission control signals to the emission control lines E1 to En.

The data driver 120 generates data signals in response to data driving control signals DCS supplied from the timing controller 150 and supplies the generated data signals to output lines D1 to Dm/i. Here, as shown in FIG. 4A and FIG. 4B, the data driver 120 sequentially supplies i (i is a natural number no less than 2) or i+1 data signals to the output lines D1 to Dm/i, respectively.

More specifically, the data driver 120 sequentially supplies red (R), green (G), and blue (B) data signals during the data period of a horizontal period 1H. In this case, since the R, G, and B data signals are supplied only in the data period, the R, G, and B data signals and the scan signals do not overlap. As shown in FIG. 4A, the data driver 120 may supply a dummy data signal DD during the scan period of the horizontal period 1H. Here, the dummy data signal DD is not used to display images. Hence, it may have various values. For example, as shown in FIG. 4B, the dummy data signal DD may be the B data signal, which is the last data signal applied in the previous data period. That is, the dummy data signal supplied during the scan period of the kth (k is a natural number) horizontal period may be the last data signal supplied during the data period of the (k−1)th horizontal period. When the dummy data signal DD is the last data signal applied in the previous data period, the data driver 120 performs fewer switching operations, which reduces power consumption.

The timing controller 150 generates the data driving control signals DCS and the scan driving control signals SCS corresponding to received synchronizing signals and supplies the data driving control signals DCS to the data driver 120 and the scan driving control signals SCS to the scan driver 110.

The demultiplexer block 160 includes m/i demultiplexers 162. That is, the demultiplexer block 160 includes one demultiplexer 162 for each output line D1 to Dm/i, and each demultiplexer 162 is coupled with one of the output lines D1 to Dm/i. Further, each demultiplexer 162 is coupled with i data lines DL. For example, FIG. 2 shows each demultiplexer 162 coupled with 3 data lines DL (i.e. i=3). The demultiplexers 162 supply the i data signals supplied in the data period to the i data lines DL, respectively.

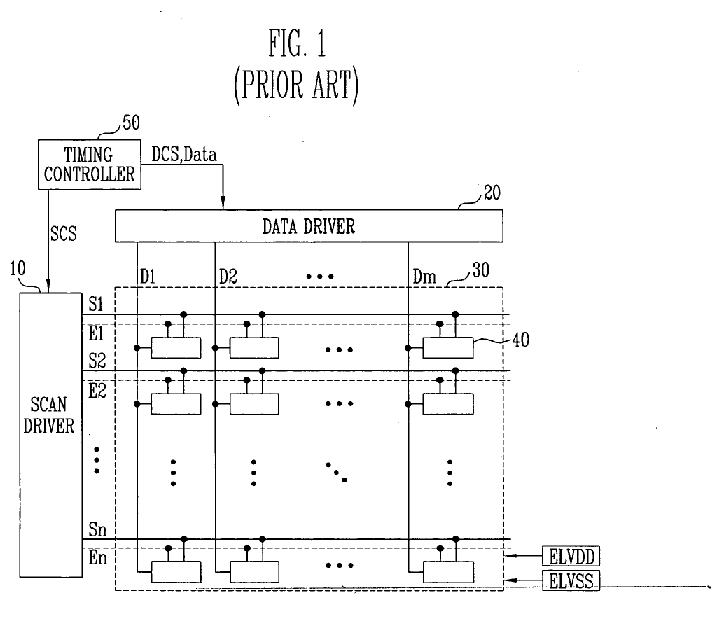

As described above, when the data signals supplied to one output line D are supplied to i data lines DL, the number of output lines included in the data driver 120 may be significantly reduced. For example, when i is 3, the data driver 120 has ⅓ the number of output lines as compared to to the conventional data driver of FIG. 1. Therefore, the number of data driving circuits included in the data driver 120 may be reduced. That is, according to an exemplary embodiment of the present invention, the data signals supplied to one output line D are supplied to i data lines DL using the demultiplexers 162 so that it is possible to reduce manufacturing costs.

The demultiplexer controller 170 supplies i control signals to the demultiplexers 162, respectively, during the data period of a horizontal period 1H so that the i data signals supplied to an output line D may be divisionally supplied to i data lines DL. Here, as shown in FIG. 4A, the demultiplexer controller 170 sequentially supplies the control signals CS1, CS2 and CS3 during the data period so that they do not overlap. FIG. 2 shows the demultiplexer controller 170 arranged outside the timing controller 150. However, the demultiplexer controller 170 may also be arranged in the timing controller 150.

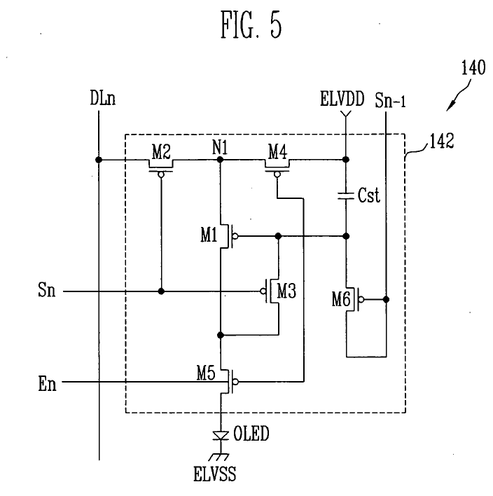

The data lines DL include data capacitors Cdata. The data capacitors Cdata temporarily store the data signals supplied to the data lines DL and supply the stored data signals to the pixels 140. Here, the data capacitors Cdata may be parasitic capacitors formed by the data lines DL. Alternatively, the data capacitors Cdata may be external capacitors arranged on the data lines DL. According to an exemplary embodiment of the present invention, as shown in FIG. 5, the capacity of the data capacitors Cdata may be larger than the capacity of storage capacitors Cst included in the pixels 140, respectively.

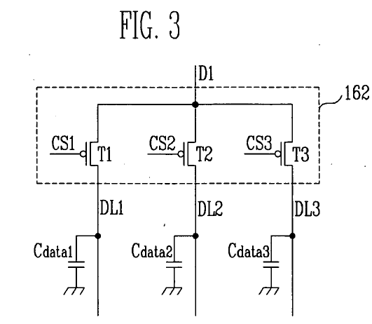

FIG. 3 is a circuit diagram showing a demultiplexer of FIG. 2.

In FIG. 3, it is assumed that i is 3 for the sake of convenience. Also, it is assumed that the demultiplexer 162 of FIG. 3 is coupled with the first output line D1.

Referring to FIG. 3, each demultiplexer 162 includes a first switching device T1 (or a transistor), a second switching device T2, and a third switching device T3.

The first switching device T1 is coupled between the first output line D1 and the first data line DL1. The first switching device T1 is turned on when a first control signal CS1 is supplied by the demultiplexer controller 170, thereby supplying the data signal supplied to the first output line D1 to the first data line DL1. The data signal supplied to the first data line DL1 is temporarily stored in a first data capacitor Cdata1.

The second switching device T2 is coupled between the first output line D1 and a second data line DL2. The second switching device T2 is turned on when a second control signal CS2 is supplied by the demultiplexer controller 170, thereby supplying the data signal supplied to the first output line D1 to the second data line DL2. The data signal supplied to the second data line DL2 is temporarily stored in a second data capacitor Cdata2.

The third switching device T3 is coupled between the first output line D1 and a third data line DL3. The third switching device T3 is turned on when a third control signal CS3 is supplied by the demultiplexer controller 170, thereby supplying the data signal supplied to the first output line D1 to the third data line DL3. The data signal supplied to the third data line DL3 is temporarily stored in a third data capacitor Cdata3. The operations of the demultiplexers 162 will be described below in detail together with the structure of the pixels 140.

FIG. 5 is a circuit diagram showing a structure of the pixel of FIG. 2. Here, the pixel structure according to the present invention is not restricted to that shown in FIG. 5, and at least one transistor included in each pixel may be used as a diode.

Referring to FIG. 5, each pixel 140 includes a pixel circuit 142 coupled with an organic light emitting diode (OLED), an nth data line DLn, an nth scan line Sn, and an nth emission control line En to emit light from the OLED.

The anode of the OLED is coupled with the pixel circuit 142, and the cathode of the OLED is coupled with a second power ELVSS. The second power ELVSS may be a voltage that is less than a first power ELVDD. For example, the second power ELVSS may be a ground voltage. The OLED generates light corresponding to the current supplied by the pixel circuit 142. The OLED is formed of an organic material.

The pixel circuit 142 includes a storage capacitor Cst and a sixth transistor M6 coupled between the first power ELVDD and the (n−1)th scan line Sn-1, a second transistor M2 and a fourth transistor M4 coupled between the first power ELVDD and the nth data line DLn, a fifth transistor M5 coupled between the anode of the OLED and a first transistor M1, the first transistor M1 coupled between the fifth transistor M5 and a first node N1, and a third transistor M3 coupled between the gate and the drain of the first transistor M1. The first to sixth transistors M1, M2, M3, M4, M5 and M6 are p-type metal oxide semiconductor field effect transistors (MOSFET) in FIG. 5, but they are not restricted to p-type MOSFETs. For example, when the first to sixth transistors M1 to M6 are n-type MOSFETs, as widely known to those skilled in the art, the polarities of driving waveforms are inversed.

The source of the first transistor M1 is coupled with the first node N1, and the drain of the first transistor M1 is coupled with the source of the fifth transistor M5. The gate of the first transistor M1 is coupled with the storage capacitor Cst. The first transistor M1 supplies current corresponding to the voltage charged in the storage capacitor Cst to the OLED.

The drain of the third transistor M3 is coupled with the gate of the first transistor M1, and the source of the third transistor M3 is coupled with the drain of the first transistor M1. The gate of the third transistor M3 is coupled with the nth scan line Sn. The third transistor M3 is turned on when the scan signal is supplied to the nth scan line Sn. When the third transistor M3 is turned on, electric current flows through the first transistor M1 so that the first transistor M1 serves as a diode.

The source of the second transistor M2 is coupled with the nth data line DLn, and the drain of the second transistor M2 is coupled with the first node N1. The gate of the second transistor M2 is coupled with the nth scan line Sn. The second transistor M2 is turned on when the scan signal is supplied to the nth scan line Sn to supply the data signal supplied to the nth data line DLn to the first node N1.

The drain of the fourth transistor M4 is coupled with the first node N1, and the source of the fourth transistor M4 is coupled with the first power ELVDD. The gate of the fourth transistor M4 is coupled with the nth emission control line En. The fourth transistor M4 is turned on when an emission control signal EMI is not supplied to electrically connect the first power ELVDD and the first node N1 with each other.

The source of the fifth transistor M5 is coupled with the drain of the first transistor M1, and the drain of the fifth transistor M5 is coupled with the anode of the OLED. The gate of the fifth transistor M5 is coupled with the nth emission control line En. The fifth transistor M5 is turned on when the emission control signal EMI is not supplied to supply the current supplied by the first transistor M1 to the OLED.

The source of the sixth transistor M6 is coupled with the storage capacitor Cst, and the drain and the gate of the sixth transistor M6 are coupled with the (n−1)th scan line Sn-1. The sixth transistor M6 is turned on when the scan signal is supplied to the (n−1)th scan line Sn-1 to initialize the storage capacitor Cst and the gate of the first transistor M1.

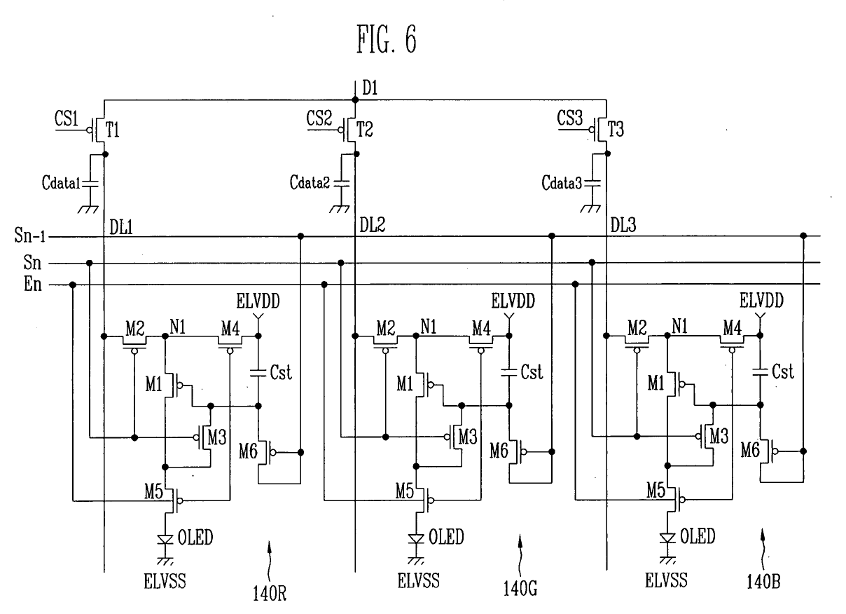

FIG. 6 shows connections between a demultiplexer and pixels according to an exemplary embodiment of the present invention. Here, it is assumed that one R, one G, and one B pixel are coupled with a demultiplexer (that is, i=3).

An operation of the demultiplexer and the R, G, and B pixels will be described in detail with reference to FIG. 4A and FIG. 6. First, the scan signal is supplied to the (n−1)th scan line Sn-1 during the scan period of a horizontal period 1H. When the scan signal is supplied to the (n−1)th scan line Sn-1, the sixth transistor M6 included in each pixel 140R, 140G, and 140B is turned on. When the sixth transistor M6 is turned on, the storage capacitor Cst and the gate of the first transistor M1 are coupled with the (n−1)th scan line Sn-1. That is, when the scan signal is supplied to the (n−1)th scan line Sn-1, the storage capacitor Cst and the gate of the first transistor M1 of each pixel 140R, 140G, and 140B have the voltage of the scan signal. Here, the voltage of the scan signal is lower than the voltage of the data signal.

When the scan signal is supplied to the (n−1)th scan line Sn-1, the second transistor M2, which is coupled with the nth scan line Sn, remains turned off.

Then, in the following data period, the first, second, and third switching devices T1, T2, and T3 are sequentially turned on by the first, second, and third control signals CS1, CS2, and CS3, respectively. When the first switching device T1 is turned on by the first control signal CS1, the data signal supplied to the first output line D1 is supplied to the first data line DL1. At this time, the voltage corresponding to the data signal supplied to the first data line DL1 is charged in the first data capacitor Cdata1.

When the second switching device T2 is turned on by the second control signal CS2, the data signal supplied to the first output line D1 is supplied to the second data line DL2. At this time, the voltage corresponding to the data signal supplied to the second data line DL2 is charged in the second data capacitor Cdata2. When the third switching device T3 is turned on by the third control signal CS3, the data signal supplied to the first output line D1 is supplied to the third data line DL3. At this time, the voltage corresponding to the data signal supplied to the third data line DL3 is charged in the third data capacitor Cdata3. However, since the scan signal is not supplied during the data period, the data signals are not supplied to the pixels 140R, 140G, and 140B.

Then, during the scan period following the data period, (i.e. the scan period of the following horizontal period 1H), the scan signal is supplied to the nth scan line Sn. When the scan signal is supplied to the nth scan line Sn, the second and third transistors M2 and M3 included in each pixel 140R, 140G, and 140B are turned on. When the second and third transistors M2 and M3 are turned on, the voltage corresponding to the data signals stored in the first, second, and third data capacitors Cdata1, Cdata2, and Cdata3 is supplied to the first node N1 of the pixels 140R, 140G, and 140B, respectively.

Here, since the voltage of the gate of the first transistor M1 included in each pixel 140R, 140G, and 140B is initialized by the scan signal supplied to the (n−1)th scan line Sn-1 (that is, is set to be lower than the voltage of the data signal applied to the first node N1), the first transistor M1 is turned on. When the first transistor M1 is turned on, the voltage corresponding to the data signal applied to the first node N1 is supplied to one side of the storage capacitor Cst via the first and third transistors M1 and M3. At this time, the voltage corresponding to the data signal is charged in the storage capacitor Cst included in each pixel 140R, 140G, and 140B. Hence, the voltage corresponding to the threshold voltage of the first transistor M1 as well as the voltage corresponding to the data signal is charged in the storage capacitor Cst. Then, when the emission control signal EMI is not supplied to the nth emission control line En, the fourth and fifth transistors M4 and M5 are turned on so that current corresponding to the voltage charged in the storage capacitor Cst is supplied to the OLED to generate light of a predetermined brightness.

That is, according to an exemplary embodiment of the present invention, it is possible to supply the data signals supplied to one output line D to i data lines DL using the demultiplexers 162. Also, voltages corresponding to the data signals are charged in the data capacitors Cdata during the data period and supplied to the pixels during the scan period. As described above, when the scan period in which the scan signals are supplied does not overlap with the data period in which the data signals are supplied, the voltage of the gate of the third transistor M3 is not changed so that it is possible to stably display images. Further, since the voltages stored in the data capacitors Cdata (i.e. the data signals) are simultaneously supplied to the pixels, it is possible to display images with substantially uniform brightness.

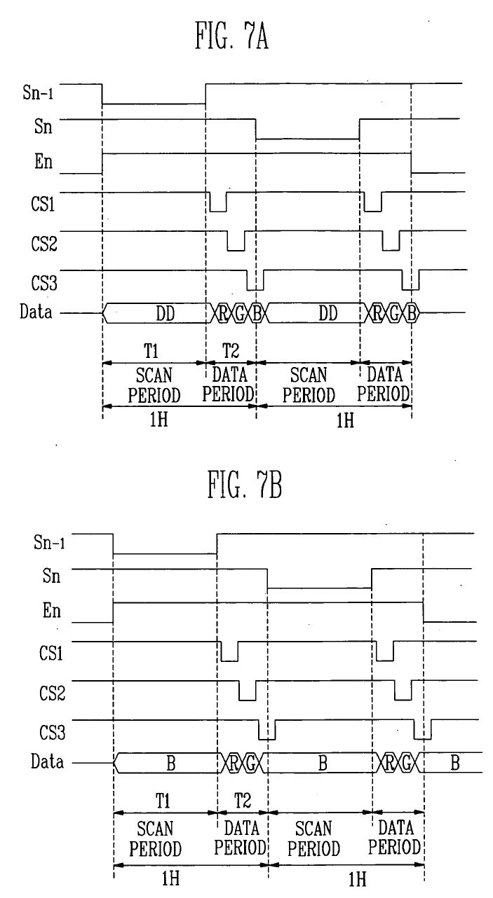

However, according to the exemplary embodiments of the present invention shown in FIG. 4A and FIG. 4B, since one horizontal period 1H is divided into the scan period and the data period, it may not be possible to secure enough scan time. Here, scan time refers to the time during which the scan signals are supplied so that the voltages corresponding to the data signals may be charged in the storage capacitors Cst of the pixels 140, respectively. If the scan time is not long enough, the pixels 140 do not display images of desired brightness. This problem may be worse with a high resolution image display 130 because as resolution increases, available scan time may shorten. In order to solve such a problem, a method of driving the light emitting display according to another exemplary embodiment of the present invention is shown in FIG. 7A and FIG. 7B.

Referring to FIG. 7A, a horizontal period 1H is divided into the scan period (the first period) and the data period (the second period). The scan driver 110 supplies scan signals in the scan period. The data driver 120 sequentially supplies a plurality of R, G, and B data signals in the data period. Here, the B data signal, which is the last data signal supplied in the data period of the kth data period, overlaps the scan period of the (k+1)th scan period.

When the last data signal supplied in the data period overlaps the scan period, it is possible to set a longer scan period. That is, it is possible to supply the scan signal for a longer period of time by overlapping the last data signal with the scan signal.

A plurality of control signals are sequentially supplied by the demultiplexer controller 170 to sequentially supply the plurality of R, G, and B data signals. Here, the control signals do not overlap each other. But the third control signal CS3 overlaps the data period and the scan period.

That is, the third control signal CS3 overlaps the scan signal so as to be synchronized with the last data signal B.

According to an embodiment of the present invention, the dummy data signal DD is supplied when the control signals CS1, CS2, and CS3 are not supplied. Here, since the dummy data signal DD is not supplied to the pixels, it may have various values. For example, as shown in FIG. 7B, the dummy data signal DD may be the B data signal, which is the last data signal supplied by the data driver 120. That is, the dummy data signal supplied in the scan period of the kth horizontal period 1H may be the last data signal supplied in the (k−1)th horizontal period 1H. When the dummy data signal DD is the last data signal that is applied in the previous data period, the data driver 120 performs fewer switching operations, which reduces power consumption.

Processes of the method of driving the light emitting display according to an embodiment of the present invention will be described in detail with reference to FIG. 6 and FIG. 7A. First, the scan signal is supplied to the (n−1)th scan line Sn-1 during the scan period of a horizontal period 1H. When the scan signal is supplied to the (n−1)th scan line Sn-1, the sixth transistor M6 included in each pixel 140R, 140G, and 140B is turned on. When the sixth transistor M6 is turned on, the storage capacitor Cst and the gate of the first transistor M1 are coupled with the (n−1)th scan line Sn-1. That is, when the scan signal is supplied to the (n−1)th scan line Sn-1, the storage capacitor Cst and the gate of the first transistor M1 of each pixel 140R, 140G, and 140B have the voltage of the scan signal. Here, the voltage of the scan signal is lower than the voltage of the data signal.

When the scan signal is supplied to the (n−1)th scan line Sn-1, the second transistor M2, which is coupled with the nth scan line Sn, remains turned off. Then, in the following data period, the first and second switching devices T1 and T2 are sequentially turned on by the first and second control signals CS1 and CS2, respectively. When the first switching device T1 is turned on by the first control signal CS1, the data signal supplied to the first output line D1 is supplied to the first data line DL1. At this time, the voltage corresponding to the data signal supplied to the first data line DL1 is charged in the first data capacitor Cdata1.

When the second switching device T2 is turned on by the second control signal CS2, the data signal supplied to the first output line D1 is supplied to the second data line DL2. At this time, the voltage corresponding to the data signal supplied to the second data line DL2 is charged in the second data capacitor Cdata2.

After the second control signal CS2 is supplied, the third control signal CS3 is supplied so as to overlap the data period and the scan period. When the third control signal CS3 is supplied, the third switching device T3 is turned on so that the data signal supplied to the first output line D1 is supplied to the third data line DL3. The data signal supplied to the third data line DL3 is stored in the third data capacitor Cdata3 and is supplied to the pixel 140B at the same time.

That is, while the third control signal CS3 is supplied, the scan signal is also supplied to the nth scan line Sn. When the scan signal is supplied to the nth scan line Sn, the second and third transistors M2 and M3 included in the pixel 140B are turned on so that the data signal supplied to the third data line DL3 is supplied to the pixel 140B, in addition to the third data capacitor Cdata3.

Then, when the scan signal is supplied to the nth scan line Sn, the second and third transistors M2 and M3 included in each pixel 140R and 140G are turned on so that the data signals stored in the first and second data capacitors Cdata1 and Cdata2 are supplied to the first node N1 of the pixels 140R and 140G, respectively.

Here, since the voltage of the gate of the first transistor M1 included in each pixel 140R, 140G, and 140B is initialized by the scan signal supplied to the (n−1)th scan line Sn-1 (that is, is set to be lower than the voltage of the data signal applied to the first node N1), the first transistor M1 is turned on. When the first transistor M1 is turned on, the voltage corresponding to the data signal applied to the first node N1 is supplied to one side of the storage capacitor Cst via the first and third transistors M1 and M3. At this time, the voltage corresponding to the data signal is charged in the storage capacitor Cst included in each pixel 140R, 140G, and 140B.

Hence, the voltage corresponding to the threshold voltage of the first transistor M1 as well as the voltage corresponding to the data signal is charged in the storage capacitor Cst. Then, when the emission control signal EMI is not supplied to the emission control line En, the fourth and fifth transistors M4 and M5 are turned on so that current corresponding to the voltage charged in the storage capacitor Cst is supplied to the OLED to generate light of a predetermined brightness.

That is, according to an exemplary embodiment of the present invention, since it is possible to supply data signals supplied to an output line D to i data lines DL, it is possible to reduce the number of output lines of the data driver. According to embodiments of the present invention, since the data signals are simultaneously supplied to the pixels, itis possible to stably display images. Also, since the last control signal may overlap the scan period, it is possible to secure an appropriate amount of scan time.

As described above, since the data signals that are supplied to one output line are divisionally supplied to a plurality of data lines, it is possible to reduce the number of output lines of the data driver, thereby reducing manufacturing cost. Also, since the points of time at which the data signals are supplied to the plurality of data lines are set to be substantially the same, it is possible to display images with substantially uniform brightness. Further, since the last control signal supplied to the demultiplexers overlaps the scan signal, it is possible to secure enough scan time and display images with desired brightness.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A light emitting display, comprising:
a scan driver for supplying scan signals to scan lines in a first period of a horizontal period;
a data driver for sequentially supplying a plurality of data signals to an output line in a second period of the horizontal period;
a demultiplexer coupled with the output line and supplying the data signals to a plurality of data lines, respectively; and
an image display including a plurality of pixels coupled with the scan lines and the data lines,
wherein the data lines comprise a capacitor for storing voltages corresponding to the data signals, and
wherein a last data signal supplied in the second period of a first horizontal period overlaps a scan signal supplied in the first period of a second horizontal period.

2. The light emitting display of claim 1, wherein the demultiplexer comprises a plurality of transistors coupled between the output line and the plurality of data lines, respectively.

3. The light emitting display of claim 2, further comprising:
a demultiplexer controller for sequentially supplying a plurality of control signals in order to sequentially turn on the plurality of transistors.

4. The light emitting display of claim 3,
wherein a last control signal among the plurality of control signals is supplied to overlap the scan signal supplied in the first period of the second horizontal period, and
wherein remaining control signals among the plurality of control signals are supplied in the second period of the first horizontal period.

5. The light emitting display of claim 4, wherein the data driver supplies a dummy data signal in the first period of the second horizontal period after the last control signal is supplied.

6. The light emitting display of claim 5, wherein the dummy data signal is set as the last data signal supplied in the second period of the first horizontal period.

7. The light emitting display of claim 1, wherein the capacitors of the data lines are parasitic capacitors formed by the data lines.

8. The light emitting display of claim 1, wherein the capacitors of the data lines are capacitors coupled with the data lines.

9. The light emitting display of claim 1, wherein the last data signal is a blue data signal.

10. A method of driving a light emitting display, comprising:
supplying a scan signal in a first period of a horizontal period; and
supplying a plurality of data signals to an output line of a data driver in a second period of the horizontal period,
wherein a last data signal supplied in the second period overlaps a scan signal.

11. The method of claim 10, wherein the first period precedes the second period, and the last data signal is supplied in the second period of a first horizontal period to overlap the scan signal, the scan signal being supplied in the first period of a second horizontal period.

12. The method of claim 10, further comprising:
transmitting the plurality of data signals to a plurality of data lines while a plurality of transistors coupled with data lines, respectively, are sequentially turned on by a plurality of control signals; and
charging voltages corresponding to the data signals in capacitors coupled with the data lines, respectively.

13. The method of claim 12,
wherein a last control signal among the plurality of control signals is supplied to overlap the scan signal, and
wherein remaining control signals among the plurality of control signals are supplied in the second period.

14. The method of claim 13, wherein a dummy data signal that does not contribute to brightness is supplied to the output line in a first period after the last control signal is supplied.

15. The method of claim 14, wherein the dummy data signal is set as the last data signal supplied in the second period.

16. The method of claim 12, wherein a capacity of the capacitors is larger than a capacity of storage capacitors included in pixels of the light emitting display, respectively.

17. A method of driving a light emitting display, comprising:
sequentially supplying scan signals; and
sequentially supplying i control signals in order to turn on i transistors coupled between an output line of a data driver and i data lines, i being a natural number,
wherein at least one control signal among the i control signals is supplied to overlap a scan signal.

18. The method of claim 17, wherein the at least one control signal that overlaps the scan signal is a last control signal among the i control signals.

19. The method of claim 17, wherein i data signals supplied to the output line are supplied to the i data lines when the i transistors are sequentially turned on.
